(19) United States
(12) Patent Application Publication
(10) Pub. No.: US 2008/0128067 A1
(43) Pub. Date: Jun. 5, 2008

(54) Heat transfer composite, associated device and method

(75) Inventors: Haluk Sayir, Bay Village, OH (US); Bob Marchiando, Twinsburg, OH (US); Evan Cooper, Orange Village, OH (US); Xiang Liu, Medina, OH (US); Marc Schaepkens, Medina, OH (US)

Correspondence Address: DILWORTH & BARRESE, LLP, 333 EARLE OVINGTON BLVD., SUITE 702, UNIONDALE, NY, 11553, US

(73) Assignee: Momentive Performance Materials Inc.

(21) Appl. No.: 11/983,288

(22) Filed: Nov. 8, 2007

Related U.S. Application Data
(63) Continuation-in-part of application No. 11/555,688, filed on Nov. 2, 2006, now abandoned.
(60) Provisional application No. 60/828,647, filed on Oct. 8, 2006.

(51) Int. Cl. B32B 37/00; B05D 1/12; B32B 7/02; B32B 15/04

(52) U.S. Cl. 156/60; 428/457; 428/215; 427/180

(57) ABSTRACT

A heat transfer composite including a plurality of pyrolytic graphite parts and a non-carbonaceous matrix holding the pyrolytic graphite parts in a consolidated mass. In one embodiment, the heat transfer composite includes a quantity of pyrolytic graphite parts randomly distributed in the non-carbonaceous matrix. In another embodiment, the heat transfer composite includes distinct layers of pyrolytic graphite parts disposed in between the layers of sheets comprising non-carbonaceous materials. In still another embodiment, the heat transfer composite comprises a substrate containing at least one non-carbonaceous matrix containing at least one pyrolytic graphite part in a consolidated mass. The matrix is affixed to the substrate for conveying heat away from a heat source.

### CROSS-REFERENCE TO RELATED APPLICATIONS

This application is a continuation-in-part application of U.S. patent application Ser. No. 11/555,688 filed Nov. 2, 2006, which claims the benefits of U.S. Patent Application Ser. No. 60/828,647 filed Oct. 10, 2006, the disclosures of which are incorporated herein by reference.

### FIELD OF THE INVENTION

The present invention relates to a heat transfer composite, a heat transfer device, and a method of manufacture.

### BACKGROUND OF THE INVENTION

Advances in microelectronics technology have resulted in electronic devices which process signals and data at unprecedented high speeds. Electronic and/or integrated circuit (“IC”) devices, e.g., microprocessors, memory devices, etc, become smaller while heat dissipation requirements get larger. The heat must be efficiently removed from the semiconductor, to prevent the system from becoming unstable or being damaged. Heat spreaders and/or heat sinks are frequently used to dissipate heat from the surface of electronic components to a cooler environment, usually ambient air.

Passive heat sinks use high thermal conductive material to move heat away from the heat-generating device into cooler areas, such as the actively cooled portion of the board, fins or surface.

Removing heat via conduction using heat transfer devices such as heat spreaders and/or heat sinks from electronic devices is a continuing area of research in the industry. U.S. Pat. No. 5,998,733 discloses an electronic housing package comprising a graphite-metal matrix composite member for dissipating heat from the system, containing 70-90 vol. % graphite in an aluminum matrix. US Patent Publication No. 20050189647 discloses a composite heat spreader comprising diamond grits embedded between layers of graphite, with a metal matrix of aluminum holding the graphite and the diamond grits in a consolidated mass. The use of diamond grits in this reference is to “allow graphite, which is an anistropic material, to be utilized in a heat spreader designed to provide isotropic heat conduction . . . ”

Diamond grits have excellent thermal conductivity property, exceeding 1300 W/m/° K in many directions. However, diamond is very expensive and has to be used as powder form and thus not a practical choice for use in thermal management devices. Diamond also has a large interface area since it has to be introduced into composite as many small grains or power. This sheer quantity of diamond particles also generate more interface for heat to pass which forms a thermal barrier and decreases the final bulk thermal conductivity. Therefore, there is still a need for thermal management materials with isotropic property. The invention relates to a heat transfer composite consisting essentially of a hyper-conductive media of pyrolytic graphite in a metal matrix, configured to provide a low-density thermal management device with relatively uniform thermal conductivity in any direction and with thermal conductivity approaching that of diamond (up to 1000 W/m/° K).

Other passive heat sinks use, for example, high conductivity thermal pyrolytic graphite material formed from pyrolytic graphite manufactured by the decomposition of a hydrocarbon gas in a high vacuum furnace to move heat away from heat-generating devices. A high performance conductivity material such as thermal pyrolytic graphite (TPG®), available from Momentive Performance Materials Inc., is a macrocomposite material that offers high conductivity, low density, and low thermal expansion properties at costs that are relatively higher than lower performing materials such as aluminum.

The TPG® provides a highly conductive path while the encapsulation material provides the structure necessary for strength, stiffness, and coefficient of thermal expansion. However, the use of a TPG® core encapsulated within a structural shell can be an expensive process. Therefore, there is still a need for thermal management materials, e.g., heat sinks and heat spreaders, which provide superior heat removal properties at effective costs.

### BRIEF SUMMARY OF THE INVENTION

The invention provides a heat transfer composite for dissipating thermal energy from an electronic device or a similar system requiring heat removal. In one embodiment, the heat transfer composite includes a plurality of pyrolytic graphite parts in a non-carbonaceous matrix holding the pyrolytic graphite parts in a consolidated mass. In one embodiment, the heat transfer composite includes a quantity of pyrolytic graphite parts randomly distributed in the non-carbonaceous matrix. In another embodiment, the heat transfer composite includes distinct layers of pyrolytic graphite parts disposed in between the layers of sheets comprising non-carbonaceous materials. In yet another embodiment, the heat transfer composite, further includes a non-carbonaceous material substrate having affixed therein at least one of matrix, wherein the matrix contains at least one pyrolytic graphite part and overlaps a heat source for conveying heat away from said heat source.

The invention further relates to a method for constructing a heat transfer composite, comprising the steps of disposing a plurality of pyrolytic graphite parts in a matrix containing a non-carbonaceous isotropic material, forming a mass or a bulk material; and heating the mass of pyrolytic graphite in the non-carbonaceous isotropic matrix to a sufficient temperature and pressure to embed the pyrolytic graphite parts in the non-carbonaceous matrix. In one embodiment, the non-carbonaceous material matrix is in the form of layers of aluminum sheets, and the pyrolytic graphite parts are distributed in between the layers of aluminum sheets.

In yet another embodiment the invention also relates to a method for constructing a heat transfer composite, comprising the steps of affixing at least one matrix to the substrate, and arranging the matrix within the substrate to overlap a heat source for conveying heat away from said heat source.

The heat transfer composite of the present invention provides a low-density, light weight thermal management systems having improved and relatively uniform thermal conductivity in a cost effective manor.

### BRIEF DESCRIPTION OF THE DRAWING

FIGS. 1A, 1B and 1C are perspective views of different embodiments of the composite blocks for use in making the heat transfer device of the invention.

FIG. 2 is a cross-section view of another embodiment of a heat transfer composite of the invention, with pyrolytic graphite parts distributed in between layers of non-carbonaceous material.

FIG. 3A is a cross-section view of another embodiment of the heat transfer composite illustrated in FIG. 2 wherein the pyrolytic graphite displays a periodic pattern.

FIG. 3B is a top view of an embodiment of the heat transfer composite illustrated in FIG. 2, showing the top view of pyrolytic graphite parts as embedded in a layer of the non-carbonaceous material.

FIG. 4 is a top planar view of an embodiment of the heat transfer composite showing the dimensions for an empty pocket or slot within the heat transfer composite substrate in which a matrix comprising at least one pyrolytic graphite part is affixed to the composite's substrate in a manner so as to overlap a heat source.

FIGS. 5A-5E are cross-section views of another embodiment of the heat transfer composite.

FIG. 5A is a cross-section view of a non-carbonaceous substrate with slots and/or pockets within the substrate.

FIG. 5B is a cross-section view of the substrate of FIG. 5A comprising pyrolytic graphite part(s) placed in the slots and/or pockets of the substrate.

FIG. 5C is a cross-section view of one embodiment of the invention wherein pyrolytic graphite parts are encapsulated in the substrate FIG. 5B.

FIG. 5D is a cross-section view of a heat transfer composite comprising a substrate having a pre-formed location for affixing one embodiment of the invention.

FIG. 5E is a cross-section view of an embodiment of the invention comprising a heat transfer composite possessing passive and active areas of heat transfer.

### DETAILED DESCRIPTION OF THE INVENTION

As used herein, approximating language may be applied to modify any quantitative representation that may vary without resulting in a change in the basic function to which it is related. Accordingly, a value modified by a term or terms, such as “substantially” may not to be limited to the precise value specified, in some cases. All ranges in the specifications and claims are inclusive of the endpoints and independently combinable. Numerical values in the specifications and claims are not limited to the specified values and may include values that differ from the specified value. Numerical values are understood to be sufficiently imprecise to include values approximating the stated values, allowing for experimental errors due to the measurement techniques known in the art and/or the precision of an instrument used to determine the values.

As used in this specification and the appended claims, the singular forms “a,” “an” and, “the” include plural referents unless the context clearly dictates otherwise. Thus, for example, reference to “a pyrolytic graphite part” or “pyrolytic graphite particle” includes one or more of such parts or particles.

As used herein, the term “part” is used interchangeably with “particle” in referencing PG particles for use as the hyper-conductive media in the heat transfer composite. As used herein, the term hyper-conductive media refers to pyrolytic graphite parts having thermal conductive property ranging from 300-1850 W/m-° K (or theoretical thermal conductivity) in the ab direction.

Heat Transfer Composite: As used herein, the term “pyrolytic graphite” may be used interchangeably with “thermal pyrolytic graphite” (“TPG”), “highly oriented pyrolytic graphite” (“HOPG”), or compression annealed pyrolytic graphite (“CAPG”), referring to graphite materials having an in-plane (a-b direction) thermal conductivity ranging from 300 W/m-° K for pyrolytic graphite, to 1800 W/m-° K for TPG, HOPG, or CAPG.

As used herein the phrase “overlap a heat source” is used to describe the thermal pyrolytic graphite's location relative to a heat source, e.g., CPU, microchip, etc. Wherein the TPG is positioned or mounted to the heat transfer composite such that at least portion and/or all of the TPG overlaps a portion and/or all of the heat source area. The thermal pyrolytic graphite's location relative to the heat source is such that a temperature gradient is formed between the two.

As used herein the term “heat transfer composite” defines a device, composition or composite which is used to provide an environment capable of absorbing heat from an object with which it is in thermal contact without a phase change or an appreciable change in temperature, such as, for example, a protective device that absorbs and dissipates the excess heat generated by a system. Other examples include, but are not limited to thermal boards, heat spreaders, heat sinks, or electronic packaging used to dissipate heat from the surface of electronic components to a cooler environment, usually ambient air.

Pyrolytic graphite (PG) is a unique form of graphite manufactured by decomposition of a hydrocarbon gas at very high temperature in a vacuum furnace. The result is an ultra-pure product which is near theoretical density and extremely anisotropic, with an in-plane thermal conductivity of 300 W/m-° K in the ab direction and 3.5 W/m-° K in the c direction. TPG, HOPG, or CAPG refers to a special form of pyrolytic graphite consisting of crystallites of considerable size, the crystallites being highly aligned or oriented with respect to each other and having well ordered carbon layers or a high degree of preferred crystallite orientation. In one embodiment, TPG has an in-plane thermal conductivity greater than 1,500 W/m-° K and <20 W/m-° K for the c direction. In another embodiment, TPG has a thermal conductivity of greater than 1,700 W/m-° K for its (a-b) planar surface.

Pyrolytic graphite (“PG”) is commercially available from GE Advanced Ceramics of Strongsville, Ohio. Pyrolytic graphite material is being commercialized in standard or custom sizes and or forms for applications ranging from thermal insulators, rocket nozzles, ion beam grids, etc. In the manufacture of pyrolytic graphite parts, there are bits and pieces of reject PG parts due to dimensional errors and or damages in processing. There are leftover PG parts from machining/drilling. There are also PG parts that are delaminated or in un-useable sizes, etc. The parts are typically discarded, and of random sizes and shapes. As used herein, the typically discarded parts will be generally referred to as “recycled PG parts.” The recycled PG parts have sizes ranging from a few microns to ten inches (in the longest dimension) in random orientation. The recycled parts have shapes ranging from random chunks or pieces to specific geometric shapes of cubic, cylindrical, half-cylindrical, square, ellipsoidal, half-ellipsoidal, wedges, and the like.

In one embodiment, the heat transfer composite of the invention employs recycled PG parts as the hyper-conductive media. In another embodiment, commercially available or “virgin” PG materials can be used as the hyper-conductive media. In a third embodiment, mixtures of recycled and virgin PG materials are used. In one embodiment where recycled parts are used, the parts may be broken into pieces and sorted into suitable size and shape categories, e.g., PG parts of less than 0.5 cm in longest dimension, PG parts of general chunk sizes of at least 1″ in the shortest dimension, PG parts that are of general elongated sizes (as a strip), etc. The sorting/sizing may be done manually, or it can be done using classifiers known in the art. In one embodiment, mixtures of PG parts with different size and shape distributions may be used to maximize the isotropic property of the heat transfer composite.

In one embodiment, the pyrolytic graphite parts are present in an amount greater than about 50% by volume of the heat transfer composite. In some embodiments, the pyrolytic graphite can be present in an amount of from about 30% to about 95% by volume. In yet other embodiments, the pyrolytic graphite can be present in an amount of from about 40% to about 60% by volume.

The pyrolytic graphite parts are incorporated in a consolidated mass of a matrix comprising a non-carbonaceous isotropic material, e.g., a metal matrix including a variety of metals and alloys, or other materials that can be diffusion bonded. As used herein, diffusion bonded or diffusion bonding means a process by which two interfaces or two materials, e.g., the pyrolytic graphite parts and the matrix material, can be joined at an elevated temperature using an applied pressure for a time ranging from a few minutes to a few hours, thus holding the plurality of pyrolytic graphite parts in a consolidated mass. In one embodiment, the elevated temperature means a temperature of about 50%-90% of the absolute melting point of the matrix material.

In one embodiment, the non-carbonaceous isotropic material comprises a metal matrix containing at least 50% aluminum by volume. In another embodiment, the metal matrix consists essentially of aluminum, which has proven effective for use as a metal matrix due to its excellent ability to wet pyrolytic graphite. As molten aluminum is infiltrated about pyrolytic graphite elements, the aluminum wets the pyrolytic graphite and forms aluminum carbide while chemically bonding with the pyrolytic graphite. As a result, any voids or air pockets within the heat transfer composite will be significantly minimized, if not eliminated altogether. The minimization of air pockets or voids within the heat transfer composite is an important consideration in that the presence of even very small pores within the heat transfer composite can significantly reduce an overall thermal conductivity of the heat transfer composite. Accordingly, in one embodiment, the heat transfer composite of the present invention is substantially free of voids or unfilled interstitial spaces between pyrolytic graphite particles.

Aluminum has a melting point of about 660° C., which generally is low enough to be used in the process to make the heat transfer composite of the invention. In some embodiments, aluminum alloys are used as the matrix of the heat transfer composite to further reduce its melting point. In one embodiment, the metal matrix comprises an aluminum alloy, e.g., an Al—Mg alloy with a melting point of about 450° C. (at the eutectic composition with about 36% wt. Mg). In a second embodiment, the metal matrix comprises an Al—Si alloy with a melting point of about 577° C. (at the eutectic composition with about 12.6% wt. of Si).

In one embodiment, the use of copper in the aluminum binder can also result in increasing the overall thermal conductivity of the heat transfer composite, which can, of course, increase the efficiency of a heat transfer device in removing heat from a heat source. In another embodiment, the matrix comprises an Al—Cu alloy with 32 wt % Cu, for a melting point of about 548° C. Other metals can also be used to increase the overall heat thermal conductivity of the heat transfer composite. For example, a metal matrix of Al—Ag, with Ag at about 26 wt %, melts at about 567° C., and provides an increase in thermal conductivity. Another example is Al—Li, with Li at about 7 wt %, melts at about 598° C.

In addition to utilizing an aluminum alloy with a relatively low melting point, in one embodiment, the metal matrix can also include various elements that reduce an overall melting point of the matrix. Suitable elements for reducing the melting point of the matrix include Mn, Ni, Sn and Zn. In another embodiment, other materials of interest that can be used in the composite of the invention include but are not limited to Fe, Cu, alloys thereof, and the like.

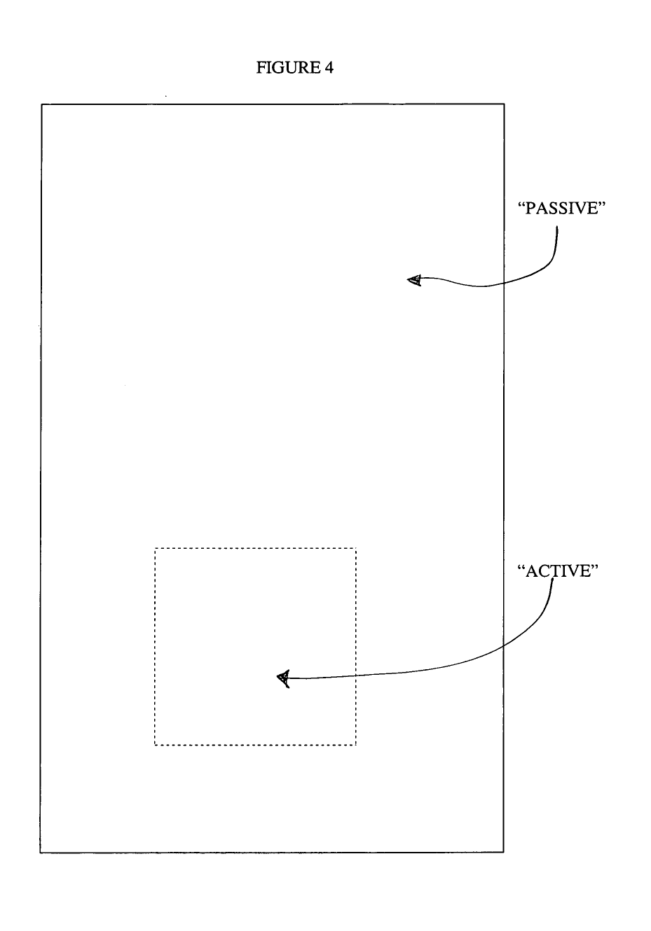

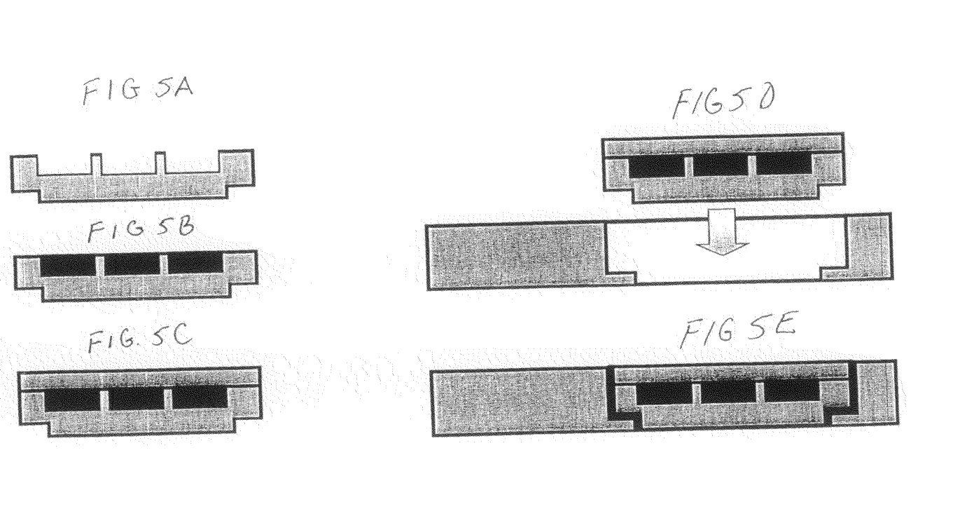

In one embodiment of the invention, heat transfer composite comprises a pre-formed substrate of non-carbonaceous material, as described herein above, which can be processed to employ hyper-conductive modules or active pre-substrates which contain at least one pyrolytic graphite part in a matrix containing a non-carbonaceous material which holds the at least one PG part, as more fully describe herein. The pyrolytic graphite part(s) of the non-carbonaceous material matrix creates an “active” area of heat transfer within the composite (see FIGS. 4 and 5E). These hyper-conductive modules or active pre-substrates, which create active areas of heat removal, can be attached or fastened (i.e., affixed, for example, epoxy bonding, mechanical screws, solder, braze, press fitting, compression fitting, hot isostatic pressing and diffusion bond process or other means) to areas, e.g., “empty pockets” or “slots” created within the composite's substrate (see FIGS. 5A-5E).

Accordingly, only the hyper-conductive modules or active pre-substrates of the heat transfer composite which are prepared with pyrolytic graphite, of various sizes, shapes, and amounts, undergo process steps, e.g., PG deposition, PG annealing, or incorporating the TPG into the pre-substrate made of, e.g., aluminum. Thus, according to one embodiment of the invention, the heat transfer composite comprises “active” areas of TPG and “passive” areas of the pre-formed substrate of non-carbonaceous material.

According to another embodiment of the invention, the pyrolytic graphite part(s) of the hyper-conductive module or active pre-substrate of the heat transfer composite is/are encapsulated or sealed with e.g., aluminum, copper, AlSiC, polymers, thermally loaded polymers and the like and mixtures thereof.

Accordingly, the active pre-substrates comprising the PG (i.e., the pyrolytic graphite can be a single piece, a plurality of pieces and/or layers of PG as described herein above) can be position to overlap a heat sources and impart a temperature gradient with the heat source and operably and/or effectively transfer heat away from the source. Moreover, the use of limited amounts of pyrolytic graphite within this embodiment of the invention provides for a heat transfer composite that is substantially more efficient and cost effective.

According to another embodiment of the invention, the heat transfer composite has a substantially flat pre-formed substrate of non-carbonaceous material. Affixed to the substrate is at least one hyper-conductive module or active pre-substrate which is prepared with at least one processed pyrolytic graphite part as more fully described herein. The active pre-substrates are affixed to the substrate such that it overlaps, partially and/or completely, a heat source. In yet another embodiment of the invention, the substantially flat pre-formed substrate comprises from about 10% to about 50% by volume of the total heat transfer composite, and in another embodiment from about 10% to about 30% by volume of the total heat transfer composite, and preferably from about 10% to about 30% by volume of the total heat transfer composite. In still another embodiment of the invention, the a-b plane of the PG parts is substantially parallel to the surface the heat transfer composite.

The active pre-substrates comprising the pyrolytic graphite parts can be affixed and/or bonded to the substrate of non-carbonaceous material by e.g., “bonding methods” which include, but are not limited to epoxy bonds, mechanical screws, solder, braze, press fitting, compression fitting, hot isostatic pressing, and/or any diffusion bond process.

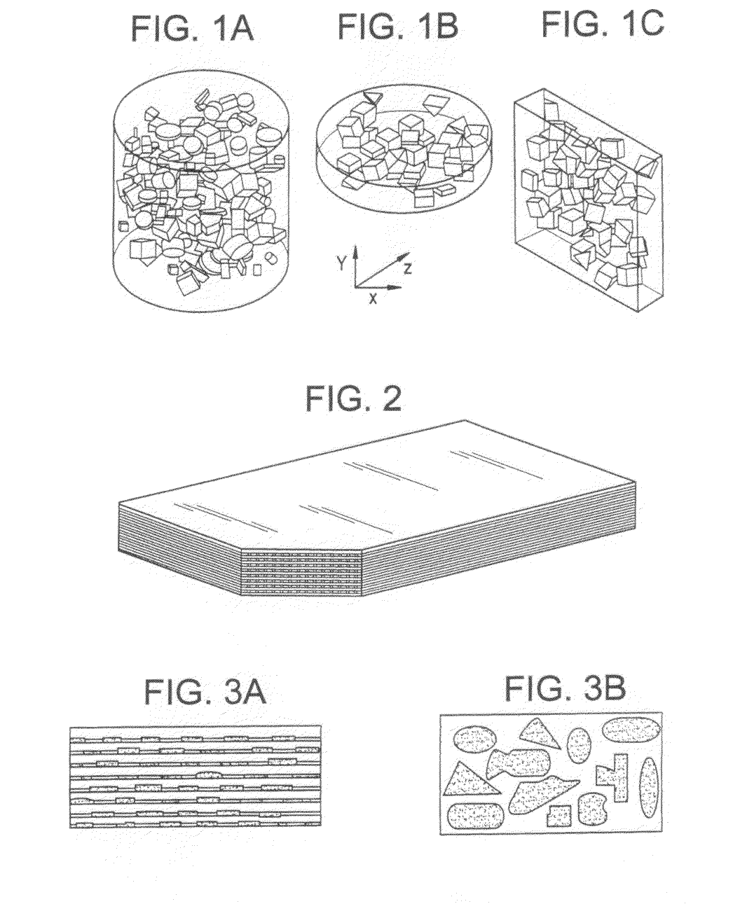

Process for Making the Heat Transfer Composite: In one embodiment as illustrated in FIGS. 1A-1C, the pyrolytic graphite particles of random sizes and/or random shapes are distributed randomly in the non-carbonaceous isotropic material, e.g., the metal matrix, of the composite. As known, pyrolytic graphite has exceptional thermal conductivity, i.e., from 300 to above 1700 W/m-° K (to about 1800 W/m-° K) in a direction along the length of the pyrolytic graphite plane, that is, in direction parallel to the graphite layers or fibers of heat spreader. As illustrated in FIGS. 1A-1C, the pyrolytic graphite particles are shown to have a random orientation within the heat transfer composite with the ab direction of the individual pyrolytic graphite pieces being at random direction relative to the xy axis. However, an orientation wherein the a-b plane of the pyrolytic graphite parts is substantially parallel to the surface of the heat transfer composite as seen in FIGS. 1A-1C is within the scope of the invention.

In one process embodiment, a desired amount of pyrolytic graphite parts is placed in a heated mold. In the next step, molten metal (such as aluminum)/alloy (or another suitable non-carbonaceous isotropic material) is applied to the pyrolytic graphite parts and substantially fill voids between the parts, forming a consolidated mass. In yet another embodiment for a variable thermal conductivity gradient in the matrix, the addition of pyrolytic graphite parts and molten aluminum can be done in stages wherein the size, shape, and or amount (concentration) of pyrolytic graphite parts added in each stage are controlled to vary the thermal conductivity in various sections of the heat transfer matrix.

In one embodiment, after a consolidated mass or matrix is formed, the mass is then machined, cut or sliced into desired thicknesses or shapes depending on the final application and the desired thermal conductivity gradient of the starting consolidated mass. In one embodiment, the heat transfer matrix is cut into strips or sheets having a thickness ranging from 0.5 mm to 2 cm. In a second embodiment, sheets are formed from the consolidated heat transfer matrix having a final thickness of 1 mm to 0.5 cm.

In another process embodiment, a heat transfer composite as illustrated in FIG. 2 is formed. In this embodiment, pyrolytic graphite pieces or parts are placed in-between layers of non-carbonaceous sheets, the layered sheets are place in a hot press forming a consolidated matrix. In one embodiment, layered sheets (pyrolytic graphite parts in between aluminum sheets) are placed in a hot press and heated to a temperature of 450-500° C. Isostatic pressure is then applied at least 300 psi and a temperature of 450 to 500° C., forming a consolidated mass or matrix. In one embodiment, isostatic pressing is done at least 500 psi.

The number of non-carbonaceous sheets such as aluminum, the thickness of the sheets, or pallets, the amount, the size, shape, and distribution of the pyrolytic graphite parts in between the sheet can be varied depending on the final application—as well as the type of pyrolytic graphite parts available. In one embodiment, the pyrolytic graphite parts are layered between the sheets such that there is a least one pyrolytic graphite part for each layer of aluminum sheet.

In one embodiment, sheets of aluminum foil having a thickness of 10 microns and 2 mm are used. In a second embodiment, aluminum sheets having a thickness of 5-25 mils are used. In a third embodiment, the composite comprising a plurality of layers has a total thickness of at least 10 mils. In a fourth embodiment, an appropriate amount of aluminum sheets are used for a final composite matrix having a final thickness of 1 mm to 0.5 cm. In one embodiment, the aluminum sheets have a nominal thickness ranging from 1/32″ to 5/18″. In a second embodiment, the aluminum sheets are 0.025″ thick.

As illustrated in FIG. 2, the pyrolytic graphite parts are distributed within the heat transfer composite in a layered orientation, wherein the pieces of pyrolytic graphite are placed such that the high conductivity plane lies parallel to the plane of the aluminum alloy sheets. In one embodiment as illustrated in FIG. 3A, the PG pieces are placed in a staggered manner and/or periodic pattern between sheets of metals such that the thermal conductivity is relatively uniform across a cross-section of the heat transfer composite (direction perpendicular to the plane of the sheets). In another embodiment as illustrated in FIG. 3B, the PG pieces are of varying shapes and geometries, e.g., small squares, pieces, or chunks, etc., depending on the availability of materials. In one embodiment (not shown), a plurality of pieces of pyrolytic graphite of relatively uniform sizes and shapes are placed in between sheets of aluminum (or aluminum alloys).

In yet another embodiment of a layered matrix of FIG. 2, a variable thermal conductivity gradient can be selectively formed in the heat transfer composite by placing more and or thicker PG pieces in between the aluminum sheets for subsequent use in a region expected to be closer to the heat source, and less pieces or thinner/smaller PG pieces in between the aluminum sheets for subsequent use in a region farther from the heat source. This aspect of the invention can be advantageous when it is desired to spread heat from a very localized area (e.g., a “hot spot”) to a heat spreader with relatively larger surface area.

In one embodiment with a random distribution of pyrolytic graphite parts in a non-carbonaceous isotropic material matrix, the (a-b) planar surface of the pyrolytic graphite parts in the composite is random, i.e., not uniform/parallel as with the prior art heat management solutions employing pyrolytic graphite.

In one embodiment with a random distribution of pyrolytic graphite parts in a non-carbonaceous isotropic material matrix, the heat transfer composite of the invention has a relatively uniform thermal conductivity, ranging from 100-1000 W/m-° K, in any direction of the composite. As used herein, “relatively uniform” means the thermal conductivity between any two spots within the matrix varies less than 25%. In one embodiment, the heat transfer composite has a thermal conductivity variation of less than 10% between any two spots within the matrix.

In one embodiment wherein the pyrolytic graphite makeup (concentration, size, shape, distribution, etc.) is carefully controlled, the thermal conductivity in the composite can be tailored to aid in matching a thermal expansion coefficient of a particular heat source. This can be beneficial in that the heat spreader and the heat source can expand and contract at similar rates to avoid compromising the bond between the heat source and the heat spreader.

According to one embodiment, as illustrated in FIG. 5C-5E, the pyrolytic graphite parts are incorporated into a consolidated mass of a matrix comprising a non-carbonaceous material and processed into a pre-substrate (see FIG. 5C), which is then positioned in the pre-formed substrate (see FIGS. 5D and 5E) of the heat transfer composite to overlap with a heat source. The active parts can be affixed to the substrate as previously described.

Applications of Heat Transfer Matrix: The heat transfer matrix of the invention can be used in connection with a variety of heat sources (none of which are shown in the figures, as examples of such heat sources typified by CPUs are well known to those of ordinary skill in the art). While not so limited, heat spreaders of the present invention can be used to transfer or conduct heat from a variety of appliances where a relatively low-cost heat spreader that can be easily formed into large shapes is desired.

In addition to the applications disclosed herein, the present invention can be used in connection with a cooling system for transferring heat away from a heat source.

Applications of the Heat Transfer Composite: The heat transfer matrix of the invention can be used in any devices, systems, and methods for transferring heat away from a heat source. In one embodiment, the heat transfer matrix is used to form heat spreaders for use in electronic and/or integrated circuit (“IC”) devices such as microprocessors, memory devices, etc.

According to another embodiment of the present invention, a specific passive heat sink or “heat sink board” is contemplated which possess superior thermal performance with respect to most of commonly used materials, such as aluminum, copper, AlSiC, etc. Passive heat sinks use high thermal conductive material to move heat away from the heat-generating device into cooler areas, such as the actively cooled portion of the heat sink board, fins or surface.

In one embodiment of the invention, the passive heat sink is a composite board that contains thermally annealed pyrolytic graphite (TPG), which has thermal conductivity higher than about 1550 Watts/Kelvin meter. Since the density of the TPG is very low with respect to most metals, the presently claimed heat sink board is lighter than many heat sinks, such as those prepared from aluminum, and offer a robust solution to the space-born, airborne, land, and marine electronics markets. However, there is a large segment of the electronics industry that still suffers heat management problems since common materials, such as aluminum, which lack sufficient thermal conductivity properties.

### EXAMPLES

Examples are provided herein to illustrate the invention but are not intended to limit the scope of the invention.

### Example 1

Pyrolytic graphite (TPG) parts from GE Advanced Ceramics of Strongsville, Ohio, are poured into a steel die sprayed with a boron nitride release agent. Molten Al—Si, with a melting point of about 577° C. is poured into the mold while simultaneously pressed and mixed with the parts by a rotating steel mixer. The molten alloy, which wetted both the pyrolytic graphite parts, filled substantially all voids between parts to create a consolidated mass heat spreader. The measured thermal conductivity of the resultant heat spreader is about 600 W/m° K. It should be noted that the performance of the board can be designed such a way that the ultimate bulk or local thermal performance can be tailored by varying the hyper-conductive media ratios.

While the invention has been described with reference to a preferred embodiment, those skilled in the art will understand that various changes may be made and equivalents may be substituted for elements thereof without departing from the scope of the invention. It is intended that the invention not be limited to the particular embodiment disclosed as the best mode for carrying out this invention, but that the invention will include all embodiments falling within the scope of the appended claims. All citations referred herein are expressly incorporated herein by reference.

1-20. (canceled)

21. A heat transfer composite, comprising:
a plurality of pyrolytic graphite parts in a matrix containing a non-carbonaceous material, holding the plurality of pyrolytic graphite parts in a consolidated mass.

22. The heat transfer composite of claim 21, wherein the pyrolytic graphite parts are present in an amount of from about 30% to about 95% by volume of the heat transfer composite.

23. The heat transfer composite of claim 21, wherein the pyrolytic graphite parts are present in an amount greater than about 50% by volume of the heat transfer composite.

24. The heat transfer composite of claim 21, wherein the pyrolytic graphite parts are present in an amount of from about 40% to about 60% by volume of the heat transfer composite.

25. The heat transfer composite of claim 21, wherein the non-carbonaceous material comprises a material that can be diffusion bonded with the plurality of pyrolytic graphite parts.

26. The heat transfer composite of claim 21, wherein the non-carbonaceous material comprises an isotropic metal matrix.

27. The heat transfer composite of claim 26 wherein the metal matrix comprises at least one of aluminum and aluminum alloys selected from the group Al—Mg; Al—Si; Al—Cu; Al—Ag; Al—Li; and Al—Be.

28. The heat transfer composite of claim 27, wherein the metal matrix includes at least an element to reduce the melting point of the metal matrix, selected from the group consisting of: Mn; Ni; Sn; and Zn.

29. The heat transfer composite of claim 21, wherein the plurality of pyrolytic graphite parts are recycled pyrolytic graphite parts.

30. The heat transfer composite of claim 21, wherein the pyrolytic graphite parts comprise at least one of pyrolytic graphite, highly oriented pyrolytic graphite, compression annealed pyrolytic graphite and mixtures thereof.

31. The heat transfer composite of claim 30, wherein the pyrolytic graphite parts have an in-plane (a-b direction) thermal conductivity ranging from 300 W/m-° K to 1800 W/m-° K and random sizes and shapes.

32. The heat transfer composite of claim 21, wherein the pyrolytic graphite parts in-plane (a-b direction) is randomly distributed in the composite.

33. The heat transfer composite of claim 32, wherein the pyrolytic graphite parts in-plane (a-b direction) is substantially parallel to the surface of the heat transfer composite.

34. The heat transfer composite of claim 21, wherein the non-carbonaceous matrix comprises a plurality of non-carbonaceous sheet layers, and wherein the plurality of pyrolytic graphite parts are disposed in-between the non-carbonaceous sheet layers.

35. The heat transfer composite of claim 34, wherein the pyrolytic graphite parts in-plane (a-b direction) is substantially parallel to the surface of the heat transfer composite.

36. The heat transfer composite of claim 35, wherein the pyrolytic graphite parts are placed in a periodic pattern within the heat transfer composite.

37. The heat transfer composite of claim 34, wherein the non-carbonaceous matrix comprises a plurality of aluminum sheet layers, and wherein the plurality of pyrolytic graphite parts are disposed in between the aluminum sheet layers, wherein there is a least one pyrolytic graphite part for each layer of aluminum sheet.

38. The heat transfer composite of claim 37, wherein the pyrolytic graphite parts in-plane (a-b direction) is substantially parallel to the surface of the heat transfer composite.

39. The heat transfer composite of claim 38, wherein the pyrolytic graphite parts are placed in a periodic pattern within the heat transfer composite.

40. The heat transfer composite of claim 34, wherein the sheet layers are hot-pressed at a temperature of at least 400° C. and at least 300 psi.

41. The heat transfer composite of claim 34, wherein the sheet layers have a thickness of at least 5 mils.

42. The heat transfer composite of claim 34, wherein the sheet layers have a nominal thickness from 1/32″ to 5/18″.

43. The heat transfer composite of claim 21, wherein the composite has a thickness of at least 10 mils.

44. A method of fabricating a heat transfer composite, comprising the steps of:
disposing a plurality of pyrolytic graphite parts in a matrix of a non-carbonaceous material, forming a mass; and
heating the mass of pyrolytic graphite parts in the non-carbonaceous matrix to a sufficient temperature and pressure to embed the pyrolytic graphite parts in the non-carbonaceous matrix.

45. The method of claim 44, wherein the non-carbonaceous material comprises an isotropic metal matrix.

46. The method of claim 44, wherein the pyrolytic graphite parts are present in an amount of from about 30% to about 95% by volume of the heat transfer composite.

47. The method of claim 44, wherein the pyrolytic graphite parts are present in an amount greater than about 50% by volume of the heat transfer composite.

48. The method of claim 44, wherein the pyrolytic graphite parts are present in an amount of from about 40% to about 60% by volume of the heat transfer composite.

49. The method of claim 44, wherein the metal includes an alloy selected from the group consisting of: Al—Mg; Al—Si; Al—Cu; Al—Ag; Al—Li; and Al—Be.

50. The method of claim 49, wherein the metal matrix includes an element to reduce the melting point of the metal matrix, the element being selected from the group consisting of: Mn; Ni; Sn; and Zn.

51. The method of claim 44, wherein the pyrolytic graphite parts comprises a mixture of pyrolytic graphite, highly oriented pyrolytic graphite, compression annealed pyrolytic graphite parts, having an in-plane (a-b direction) thermal conductivity ranging from 300 W/m-° K to 1800 W/m-° K.

52. The method of claim 44, wherein the step of disposing the plurality of pyrolytic graphite parts in the non-carbonaceous matrix comprises distributing the plurality of pyrolytic graphite parts in between layers comprising a non-carbonaceous material.

53. A heat transfer device comprising the heat transfer composite of claim 21.

54. The heat transfer composite of claim 21, further comprising a non-carbonaceous material substrate having affixed therein at least one of said matrix, wherein the matrix comprises at least one pyrolytic graphite part and overlaps a heat source for conveying heat away from said heat source.

55. The heat transfer composite of claim 54, wherein the substrate is substantially flat and the in-plane (a-b direction) of the at least one pyrolytic graphite part is substantially parallel to the surface of the heat transfer composite.

56. The heat transfer composite of claim 54, wherein the pyrolytic graphite part(s) has an in-plane thermal conductivity of at least about 300 W/m-° K in a-b direction and less than about 20 W/m-° K in c direction.

57. The heat transfer composite of claim 54, wherein said matrix is affixed to the substrate by a process which is at least one selected from the group consisting of epoxy bonding, mechanical screws, solder, braze, press fitting, compression fitting, hot isostatic pressing and diffusion bond process.

58. The heat transfer composite of claim 54, wherein the substrate of non-carbonaceous material comprises an isotropic metal comprising at least one of aluminum and aluminum alloys selected from the group Al—Mg; Al—Si; Al—Cu; Al—Ag; Al—Li; and Al—Be.

59. The heat transfer composite of claim 58, wherein the substrate includes at least an element to reduce the melting point of the metal substrate, selected from the group consisting of: Mn; Ni; Sn; and Zn.

60. The heat transfer composite of claim 54, wherein matrix comprises a non-carbonaceous material that can be diffusion bonded with at least one pyrolytic graphite part.

61. The heat transfer composite of claim 60, wherein the non-carbonaceous material of the matrix comprises an isotropic metal matrix.

62. The heat transfer composite of claim 61, wherein the metal matrix comprises at least one of aluminum and aluminum alloys selected from the group Al—Mg; Al—Si; Al—Cu; Al—Ag; Al—Li; and Al—Be.

63. The heat transfer composite of claim 62, wherein the metal matrix includes at least an element to reduce the melting point of the metal matrix, selected from the group consisting of: Mn; Ni; Sn; and Zn.

64. The heat transfer composite of claim 54, wherein the at least one pyrolytic graphite part of the matrix is recycled pyrolytic graphite.

65. The heat transfer composite of claim 64, wherein the pyrolytic graphite part comprises at least one of pyrolytic graphite, highly oriented pyrolytic graphite, compression annealed pyrolytic graphite, having an in-plane (a-b direction) thermal conductivity ranging from about 300 W/m-° K to 1800 W/m-° K.

66. The heat transfer composite of claim 54, wherein the pyrolytic graphite part(s) is present in an amount that ranges from about 10 percent to about 50 percent by volume of the heat transfer composite.

67. The heat transfer composite of claim 54, wherein the pyrolytic graphite part(s) is present in an amount that ranges from about 10 percent to about 30 percent by volume of the heat transfer composite.

68. The heat transfer composite of claim 54, wherein the pyrolytic graphite part(s) is present in an amount that ranges from about 20 percent to about 30 percent by volume of the heat transfer composite.

69. The heat transfer composite of claim 54, wherein the pyrolytic graphite part(s) is at least one of random sizes, random shapes, different sizes, and different shapes.

70. The heat transfer composite of claim 54, wherein the matrix comprises a plurality of non-carbonaceous sheet layers, and wherein the at least one pyrolytic graphite part is disposed on and/or in-between the non-carbonaceous sheet layers.

71. The heat transfer composite of claim 70, wherein the non-carbonaceous sheet layers are aluminum, and wherein the at least one pyrolytic graphite part is disposed on and/or in-between the aluminum sheet layers.

72. The heat transfer composite of claim 70, wherein the at least one pyrolytic graphite part is placed in a periodic pattern within the heat transfer composite.

73. The heat transfer composite of claim 71, wherein the layered sheets are hot-pressed at a temperature of at least 400° C. and at least 300 psi.

74. The heat transfer composite of claim 71, wherein each of the aluminum sheets have an average thickness of at least 10 mils.

75. The heat transfer composite of claim 54, wherein the composite has a thickness of at least 10 mils.

76. A method for constructing the heat transfer composite of claim 54, comprising the steps of:
affixing at least one matrix to the substrate; and,
arranging the matrix within the substrate to overlap a heat source for conveying heat away from said heat source.

77. The method of claim 76, where the at least one pyrolytic graphite part has an in-plane thermal conductivity of at least about 300 W/m-° K in a-b direction and less than about 20 W/m-° K in c direction.

78. The method of claim 76, wherein the wherein the substrate of non-carbonaceous material comprises an isotropic metal.

79. The method of claim 78, wherein the metal substrate includes an alloy selected from the group consisting of: Al—Mg; Al—Si; Al—Cu; Al—Ag; Al—Li; and Al—Be.

80. The method of claim 79, wherein the substrate includes an element to reduce the melting point of the metal, the element being selected from the group consisting of: Mn; Ni; Sn; and Zn.

81. The method of claim 76, wherein matrix comprises a non-carbonaceous material that can be diffusion bonded with at least one pyrolytic graphite part.

82. The method of claim 81, wherein the non-carbonaceous material of the matrix comprises an isotropic metal matrix.

83. The method of claim 82, wherein the metal matrix comprises at least one of aluminum and aluminum alloys selected from the group Al—Mg; Al—Si; Al—Cu; Al—Ag; Al—Li; and Al—Be.

84. The method of claim 83, wherein the metal matrix includes at least an element to reduce the melting point of the metal matrix, selected from the group consisting of: Mn; Ni; Sn; and Zn.

85. The method of claim 76, wherein the pyrolytic graphite part comprises at least one of pyrolytic graphite, highly oriented pyrolytic graphite, compression annealed pyrolytic graphite, having an in-plane (a-b direction) thermal conductivity ranging from about 300 W/m-° K to 1800 W/m-° K.

86. A heat transfer device comprising the heat transfer composite of claim 54.
